(19) United States
(12) Patent Application Publication
(10) Pub. No.: US 2007/0294356 A1
(43) Pub. Date: Dec. 20, 2007

(54) User selection type e-mail delivery system

(76) Inventor: Yasuyoshi Shimooka, Tokyo (JP)

Correspondence Address: Robert Popa, Esq.;c/o LADAS & PARRY, Suite 2100, 5670 Wilshire Boulevard, Los Angeles, CA, 90036-5679, US

(21) Appl. No.: 11/471,976

(22) Filed: Jun. 20, 2006

(51) Int. Cl. G06F 15/16

(52) U.S. Cl. 709/206

(57) ABSTRACT

A mail magazine delivery system is customized to suit categories that a user desires, by containing in the contents to be delivered as a mail magazine an option to select future mail delivery and giving the user a choice as to future mail delivery. User terminals and a delivery server for delivering mail contents are connected to each other through an electronic communication medium. The delivery server has a users database, a contents database, a contents selection means, an option insertion means, a mail generation means, a management server sending/receiving means, and an option determination means.

### BACKGROUND OF THE INVENTION

1. Field of the Invention

The present invention relates to a user selection type e-mail delivery system, and more specifically, to a user selection type e-mail delivery system for providing variable mail delivery by containing an option in the contents, depending on a user's selection.

2. Description of the Prior Art

Conventionally, with the progress of computer technologies and communication technologies, a huge volume of information has been exchanged in various industries by means of electronic communication media, such as public communication networks, private communication networks and the like. Based on the widespread proliferation of the Internet, companies have made use of websites and e-mails as their own advertising medium and sales promotional strategy.

Especially, regarding e-mails, a mail delivery service called an e-mail magazine that provides general users or particular users various information is popular. For example, when a user, who desires delivery of mail magazines, registers his or her own user information and a category that the user desires to be mail-delivered at a Website or at a time of user registration of software, an e-mail regarding the registered category is delivered to the mail address of the registered user.

For effective mail magazine delivery, it is usual that the registered user information is compiled into a database, and subscribers are determined by consulting the database beforehand. For example, Japanese Unexamined Patent Publication No. 2004-145511 discloses a mail delivery apparatus which can determine subscribers by using the latest user registration database, deliver e-mails having contents suitable for the respective subscriber users, based on a predetermined delivery schedule, and provide user registration screen data associated with the delivery schedule; delivery method; delivery program; and a recording medium storing the program.

However, a category that a user selects when the user subscribes to a mail magazine is abstractly categorized such that the user can more easily select. And, in fact, the user cannot select detailed categories. Therefore, in spite of selecting a category that the user desires, there is a case that a mail magazine not necessary for the user is delivered. Especially, a mail magazine unnecessary for the user has a bilateral character that such an unnecessary mail also becomes an unsolicated mail for the user.

According to the techniques disclosed in the aforementioned publication, a delivery schedule called scenario is used for delivering a mail magazine suitable for subscriber users. With this approach, however, dropouts of deliverer mails and mail delivery after being unsubscribed are prevented, but details of the contents cannot be controlled.

### SUMMARY OF THE INVENTION

Accordingly, in view of the foregoing problems, an object of the invention is to provide a mail magazine delivery system that is customized to suit categories that a user desires, by containing in the contents to be delivered as a mail magazine an option to select future mail delivery and giving the user a choice as to future mail delivery.

The present invention relates to a user selection type e-mail delivery system, and more specifically, to a user selection type e-mail delivery system for providing variable mail delivery by containing an option in the contents, depending on a user's selection. The object of the invention is achieved by connecting user terminals that customers have and a delivery server for delivering mail contents through an electronic communication medium, and providing the delivery server such that it comprises the following: a users database storing therein user information of users; a contents database storing therein contents to be provided to the users; contents selection means for selecting from the user information first contents to be provided to the users; option insertion means for reading out from the first contents an option for selecting second contents associated with the first contents and inserting the second contents into the first contents; mail generation means for generating a mail containing the first contents; management server sending/receiving means for sending the mail and receiving option information input through the user terminal; and selection determination means for determining the input option.

Further, the aforementioned object is more effectively achieved by containing an option of unsubscribing from mail delivery in the inserted option or providing a plurality of contents associated with the first contents and inserting a plurality of the options in the first contents by the option insertion means or by providing the delivery server with a contents input means for storing new contents into the contents database.

### BRIEF DESCRIPTION OF THE DRAWINGS

FIG. 1 is a schematic diagram showing the overall layout of a system according to the invention and the internal construction thereof; and

FIG. 2 is a flowchart showing an exemplary operation when mail delivery of the invention is carried out.

### DESCRIPTION OF THE PREFERRED EMBODIMENTS

The present invention provides a system that prepares an option to go to the next content within contents of a mail magazine delivered to a user, reflects the user's selection to the next mail delivery, and thereby delivering contents of categories that are a favorite for the user.

Hereinafter, a description will be given with reference to the drawings.

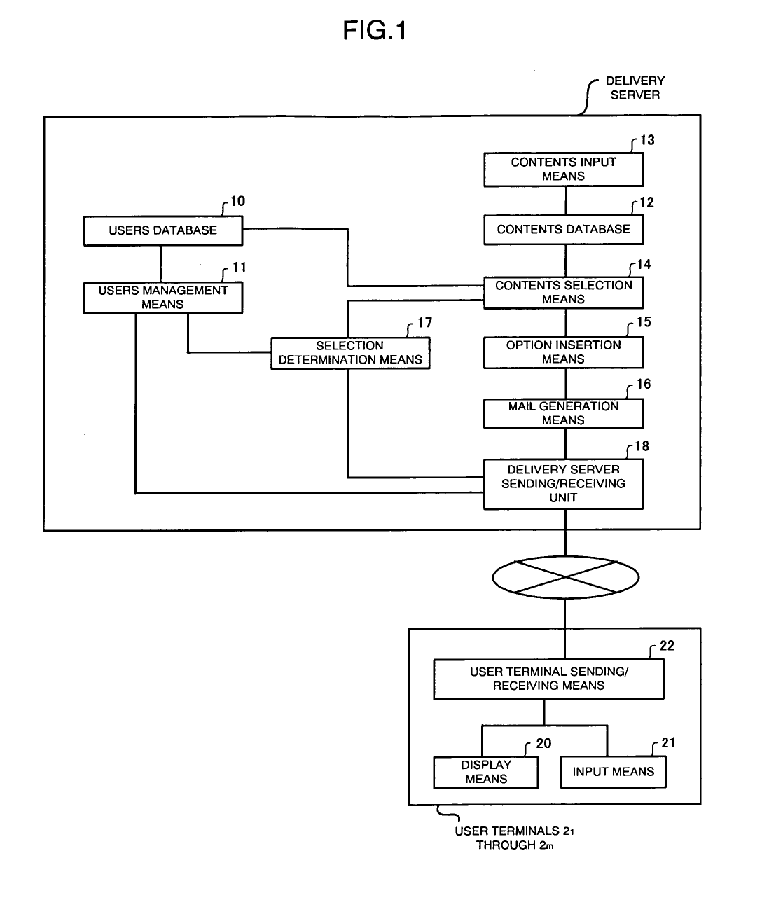

FIG. 1 is one example of a schematic diagram showing the overall layout of a system of the present invention and the internal construction thereof.

In this system, user terminals 2₁ . . . 2ₘ through which a user reads a delivered mail magazine and a delivery server 1 for delivering a mail magazine to the user terminals 2₁-2ₘ are connected to each other by means of an electronic communication medium.

The delivery server 1 comprises the following: a users database 10 storing therein user information of users; a users management section 11 for managing new registration, registered information change and the like of the users; a contents database 12 storing therein contents to be delivered as a mail magazine; a contents input means 13 for inputting contents to the contents database 12; a contents selection means 14 for selecting contents to be delivered based on the user information; an option insertion means 15 for inserting an option regarding contents to be delivered next time into the contents to be delivered this time; a mail generation means 16 for generating a mail magazine to be sent to the user terminal 2₁-2ₘ; an option determination means 17 for determining options selected at the user terminal 2₁-2ₘ; and a delivery server sending/receiving means 18 for sending and receiving information to and from each user terminal 2₁-2ₘ through the electronic communication means.

Each of the user terminals 2₁-2ₘ comprises: a display means 20 provided for a user to view a delivered mail magazine; an input means 21 through which a user makes some input; and a user terminal sending/receiving means 22 which sends data to and receives data from the delivery server 1 through the electronic communication means.

As used herein, the user information is at least a user's mail address and a favorite category of the user.

The contents input means 13 is used for registering the new contents information in the contents database 12 when the information is generated.

In the following, a delivery flow of mail magazines using the present system will be described in connection with the flowchart.

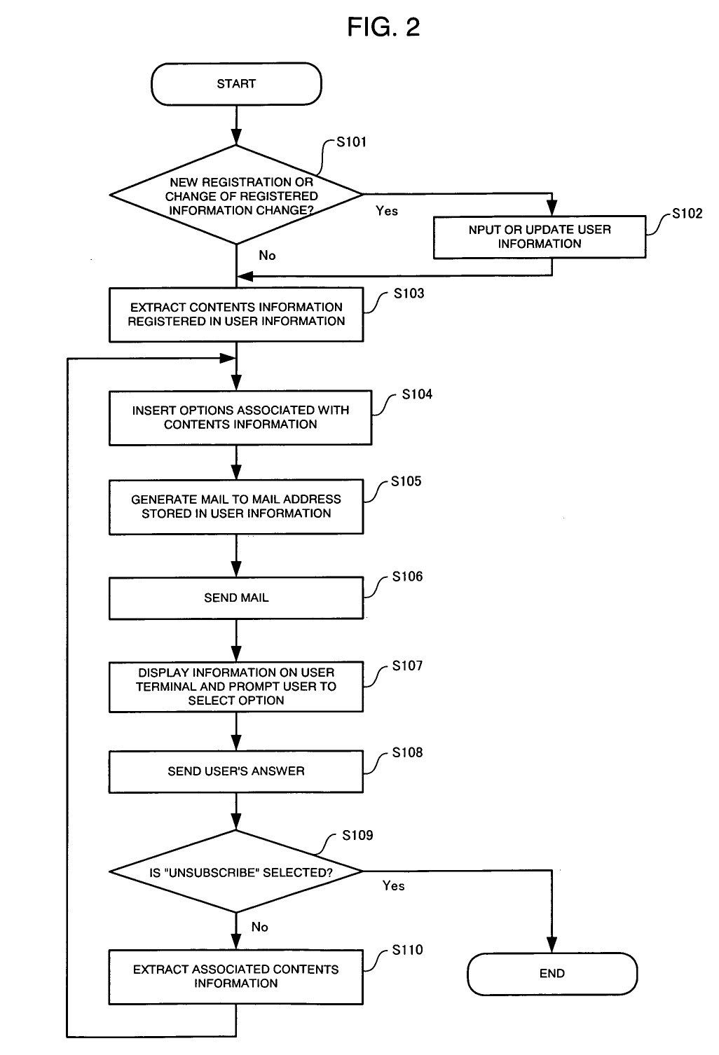

FIG. 2 is an example of the flowchart showing a flow of the system.

First, for a user desiring delivery of a mail magazine, new registration is necessary. Furthermore, a user who wishes a change of mail address, addition of a favorite category, and unsubscribing to mails must change registered information (step S101). When new registration or a change of registration is conducted (step S101, YES), connection is made from the user terminals 2₁-2ₘ to the delivery server. In the delivery server 1 after the connection is confirmed, the user management means 11 sends a Web page to the user terminals user terminal 2₁-2ₘ. Then, a user inputs user information through the input means 21 using a format displayed on the display means 20. Alternatively, a Web page may be sent in such a way to be supplied to the user terminal 2₁-2ₘ through another server (not shown) when a Web page send request is transmitted from the server (not shown).

The delivery server 1 receives the input user information from the user terminals 2₁-2ₘ, and the user management device 11 updates the users database 10 based on the new registration or the change of the user information (step S102). Also in this case, update may be carried out, as described above, such that another server (not shown) receives the user information and sends the information to the delivery server 1.

When the user registration has been done or no update is conducted, the algorithm branches to the next step (step S101, NO).

In response to the registration of the user information to the users database 10, the delivery server 1 regularly delivers mail magazines.

First, the contents selection means 14 refers to desired contents (favorite categories) registered in the user information stored in the users database, and calls first relevant contents information from the contents database 12 (step S103)

The first contents information is associated with the articles of the contents as well as information regarding second contents to be delivered next, and stored in the contents database 12.

The option input means 15 identifies the information representing the second contents information to be delivered next time, which is associated with the first contents information to be delivered this time, and inserts an option for selecting contents information to be delivered next time within the contents information to be delivered this time. (step S104). This option should be inserted such that it can be displayed on the display means of the user terminal 2₁-2ₘ. In order to know the contents more desirable for users, it is preferable that the information representing the second contents information to be delivered next time is wide ranging. In other words, the number of options is preferably two or more, not one. More preferably, the options contain the option to unsubscribe from future mail magazines.

Such that the first contents information, having the options inserted therein for selecting the second contents information to be sent next, can be sent to the user terminals 2₁-2ₘ as a mail magazine, the mail generation means 16 generates a mail within which the first contents information is contained (step S105).

The generated mail magazine is sent to the user terminals 2₁-2ₘ through the delivery server sending/receiving means 18 (step S106).

As the user terminal 2₁-2ₘ receives the delivered mail magazine, its user open the mail, whereby the contents of the first contents information and the aforementioned option are displayed on the display means 20. Referring to the option, selection and input are performed by the user using the input means 21 (step S107). This selection input information is sent to the delivery server 1 through an electronic communication medium using the user terminal sending/receiving means 22 (step S108).

In the delivery server 1 receiving the selection input information, the selection determination means 17 determines which option is selected. When it is determined that the option “unsubscribe” is selected and input (step S109, YES), an instruction to unsubscribe from mail delivery is sent from the selection determination means 17 to the users management means 11, and the user information stored in the user database 10 is updated, and the processing completes.

Further, when the user desires delivery of mails of other categories, what is necessary is only updating the categories. If the user does not desire delivery of mails of other categories, it is preferable to delete the user information itself.

When it is determined that an option other than “unsubscribe” is selected and input (step S109, NO), the selected and input option information is sent to the contents selection means 14.

The contents selection means 14 reads out the second contents information based on the selection input (step S110).

After that, for a third contents information associated with the second contents information, an option is similarly generated, and such a procedure is repeated to the end.

By this selection input, the user's favorite categories become limited. If the user information stored in the users database is updated based on this limitation, delivery which further suits the user's taste would become possible.

Further, for delivery of contents information, a clock means (not shown) may be separately provided such that a mail magazine is delivered at a time that a user desires. In this case, the information regarding the time the user desires should be further contained in the user information.

The present invention enables mail delivery of categories that further meets the user's desire by containing options regarding the next mail magazine within the contents of the mail magazine to be delivered to the user terminals.

In addition, containing an option to unsubscribe future mails enables preventing a mail being delivered to the user from becoming an unsolicated mail.

Further, since the user is prompted to select the contents of the mail magazine each time, it becomes possible to consistently keep sending a narrative and relevant contents, and in addition to flexibly accommodating a change in the preference of the user.

1. A user selection type mail delivery system, wherein
user terminals that customers have and a delivery server for delivering mail contents are connected through an electronic communication medium, and
the delivery user comprising:
a users database storing therein user information of users;
a contents database storing therein contents to be provided to the users;
contents selection means for selecting from the user information the first contents to be provided to the users;
option insertion means for reading out from the first contents an option for selecting the second contents associated with the first contents and inserting the second contents into the first contents;
mail generation means for generating a mail containing the first contents;
management server sending/receiving means for sending the mail and receiving option information input through the user terminal; and
selection determination means for determining the input option.

2. The user selection type mail delivery system according to claim 1, wherein the inserted option contains an option of unsubscribing from mail delivery.

3. The user selection type mail delivery system according to claim 1, wherein a plurality of contents are associated with the first contents, and the option insertion means inserts a plurality of the options in the first contents.

4. The user selection type mail delivery system according to claim 1, wherein the delivery server further comprises a contents input means for storing new contents into the contents database.
